(19) United States
(12) Patent Application Publication
(10) Pub. No.: US 2023/0085642 A1
(43) Pub. Date: Mar. 23, 2023

(54) PROCESS CONTROL SYSTEM (PCS) BENCHMARKING TOOL

(71) Applicant: Saudi Arabian Oil Company, Dhahran (SA)

(72) Inventors: Majed Omar Mohammad Rubaiyan, Dammam (SA); Matthew Edward Barry Stephansson, Dhahran (SA); Abdulrahman Saleh A. Alghamdi, Dammam (SA); Abdullah Yahya A. Al Zahrani, Dammam (SA); Qasim Hassan S. Altowailib, Qatif (SA)

(21) Appl. No.: 17/448,462

(22) Filed: Sep. 22, 2021

(51) Int. Cl. G06Q 30/02; G06F 16/245

(52) U.S. Cl. CPC G06Q 30/0283; G06F 16/245

(57) ABSTRACT

Systems and methods include a process for generating negotiation targets and estimates for new PCS purchase agreements. A process control system (PCS) benchmarking database is generated using a PCS benchmarking tool and historical data from past and ongoing PCS purchase agreements. The PCS benchmarking database is maintained during execution of purchase agreements using information from executed purchase agreements. A new PCS purchase agreement is compared to previous PCS purchase agreements using the PCS benchmarking tool and the PCS benchmarking database. Negotiation targets and estimates for the new PCS purchase agreement are generated using the PCS benchmarking tool based on the comparing.

### TECHNICAL FIELD

The present disclosure applies to process control systems and associated proposals and costs.

### BACKGROUND

Process control systems are installed and used in virtually all plants and factories. The systems can make it possible to control processes, including continuous production processes, in an automatic and consistent way that is not possible for humans alone to achieve. Such processes can make projects more stable and can improve production while maintaining safety. Costs associated with projects can vary based on costs associated with a company and its suppliers.

### SUMMARY

The present disclosure describes techniques that can be used to benchmark costs associated with process control systems. In some implementations, a computer-implemented method includes the following. A process control system (PCS) benchmarking database is generated using a PCS benchmarking tool and historical data from past and ongoing PCS purchase agreements. The PCS benchmarking database is maintained during execution of purchase agreements using information from executed purchase agreements. A new PCS purchase agreement is compared to previous PCS purchase agreements using the PCS benchmarking tool and the PCS benchmarking database. Negotiation targets and estimates for the new PCS purchase agreement are generated using the PCS benchmarking tool based on the comparing.

A Process Control System (PCS) of the present disclosure is an integrated system which is used to monitor and control an operating facility. The PCS consists of a Distributed Control System and other related monitoring and auxiliary control systems including Plant Information Systems which are connected to form a single integrated system. The Distributed Control System is composed of distinct controllers and input/output (I/O) modules which are physically and functionally distributed over the plant area to accomplish the regulatory control and monitoring of a process plant.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. Tools and techniques can be focused on presenting specialists in process control system (PCS) procurement with a holistic view and understanding of the pricing of PCS proposals (e.g., with or without contracts). The tools and techniques can break down PCS proposals to identify main elements and factors that drive their pricing. The magnitude of the effect of each identified element or factor on a proposal's price can be evaluated. Data that is collected can be used to help PCS procurement personnel build predictive models used in procurement strategies and planning, for example, through more highly-accurate budgeting and estimating. Pricing data can be analyzed and broken down in a number of ways to better understand the commercial value of a proposal and a project. The tools and techniques can facilitate conduct negotiation, estimate costs, and achieve cost savings based on quantitative analysis. The tools and techniques can be developed, tested, and verified so that a hypothesis regarding a PCS project's sizing and cost can be significantly correlated, either directly or indirectly, with various interrelated factors. PCS project variables can be translated into several qualitative and quantitative parameters and used to perform detailed analysis. A method can be used to measure the magnitude that each parameter contributes to a PCS project's cost. Main factors that primarily influence a PCS projects' sizing and cost can be identified. Causal interrelationships between the identified factors can be established for a PCS project's commercial and technical proposals. Applicable variables for PCS benchmarking among multiple suppliers can be identified. A conceptual basis for a benchmarking and negotiation target setting model can be developed. The tools and techniques can be continuously enhanced to make user interfaces more user friendly. Data can be extracted from signed agreements to build a costs database used by the tools and techniques. Tool functionality and accuracy can be regularly tested. Relationships between a PCS project's sizing and cost and correlations with various interrelated factors can be developed, tested and verified. Applicable variables for PCS benchmarking among multiple suppliers can be identified. Multiple conditions/variables influencing benchmarking scenarios can be identified. A mechanism for utilizing benchmarking results to set negotiation strategies and targets can be developed. A specific advantage of the tool is the use in single or sole source scenarios where the user is at a distinct commercial disadvantage with the vendor. The tool can generate information to compare and contrast both competitive and single/sole source placements and give ranges for the user to negotiate within

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a flow diagram showing an example of a workflow for performing benchmark activities, according to some implementations of the present disclosure.

FIG. 2 is a block diagram showing example data inputs to a process control system (PCS) benchmarking tool database, according to some implementations of the present disclosure.

FIG. 3 is a flow diagram showing an example of a workflow for providing user input for benchmark activities and displaying results, according to some implementations of the present disclosure.

FIG. 4 is a flowchart showing an example of a method for generating negotiation targets and estimates using the PCS benchmarking database, according to some implementations of the present disclosure.

FIG. 5 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques that can be used to benchmark costs associated with process control systems. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

A process control system (PCS) benchmarking tool can be used to support the commercial analysis of complex PCS proposals. Each PCS proposal is unique in nature, tailored to the needs of the process, and the technical requirements of the project, including green and brown projects. Without the use of a benchmarking tool, understanding the commercial value of a particular PCS proposal can be challenging. The goal of using the tool is to evaluate and benchmark PCS proposals with historical information, which can be used to develop negotiation strategies. For example, structured mechanisms can be used for estimating and establishing negotiation targets to achieve costs that are reasonable for both a company and the company's suppliers.

Process control systems are typically installed in all company plants. Systems benchmarking can allow a procurement team to estimate the reasonable costs of the project as well as establishing negotiation targets. This can allow the company to perform meaningful negotiations that lead to significant price reductions.

### PCS Benchmarking Tool Database

A PCS benchmarking tool can be constructed to use a database derived from executed PCS purchase agreements. The agreements can be any type of purchase agreement (for example, purchase orders, contracts, and long-term agreements), as long as the agreement represents an actual signed contract between a buyer and a seller for PCS materials. Data included in the database does not include data from proposals that have been received but never executed through a purchase agreement. By only using data from executed agreements in the database, the level of subjectivity in the benchmarking conclusions can be reduced.

### Building the Database

A typical starting point for an organization deploying the PCS benchmarking tool is the development of a database. The database can serve as the foundation of the tool and can be based on an individual organization's history procuring PCS material. The organization can focus on entering as much data as possible into the database, which in turn can increase the reliability of the benchmarking data that the tool produces.

Data ordered into the data [symbol] PCS purchase agreement. This can allow the evaluator reviewing benchmarking results to understand the context of system cost in relation to the overall agreement with which it was purchased. In some implementations, the following Tier 1 and Tier 2 data can form the content of the PCS benchmarking tool database.

### Tier 1 Data—Agreement Level

The data under Tier 1 can be associated with the PCS purchase agreement, and not the specifics of the individual PCS systems covered by the agreement. Optional data can be added to the database-based organization requirements, and for better referencing in the outputs of the PCS benchmarking tool.

In some implementations, some Tier 1 data can be mandatory data. The mandatory data can include, for example, PCS purchase agreement number, project type, PCS purchase agreement development methodology, agreement award date, PCS purchase agreement vendor, PCS purchase agreement value, PCS purchase agreement material value, PCS purchase agreement engineering value, and PCS purchase agreement engineering hours.

In some implementations, some Tier 2 data can be optional data. The optional data can include, for example, additional project references, request for quote (RFQ)/RFQ issue date, RFQ/RFQ bid closing date, technical evaluation completion date, commercial evaluation completion date, and cost savings.

### Tier 2 Data—Core System Level

In some implementations, systems that are covered under Tier 2 data include core systems such as distributed control systems (DCS), emergency shutdown systems (ESD) and burner management systems (BMS), vibration monitoring system (VMS) and condition monitoring system (CMS), and compressor control system (CCS). Core systems can be sized based on the number of I/O operations associated with the system. The database can be sized to allow for an entry of each of the mandatory and optional data per system. However, it may be the case that not every system is mandatory to be entered (based on the systems purchased under the specific PCS purchase agreement). In the following lists of mandatory and optional data (and in other sections of the present disclosure), “*” is a place holder for a given core system name (e.g., “DCS”), indicating that each of the named data elements exists for DCS, ESD/BMS, VMS/CMS, and CCS.

In some implementations, Tier 2 data elements can be mandatory data. The mandatory data can include, for example, * vendor, * system selection methodology, * value (for example, in United Stated dollars (USD)), * material value (for example, in USD), * services value (for example, in USD), * services hours, and * I/O count.

In some implementations, Tier 2 data elements can be optional data. The optional data can include, for example, * system name, and * system version.

### Maintaining the Database

As an organization executes more PCS purchase agreements, the database can be expanded. Expansion can be done on regular intervals to ensure that benchmarking tool is adapting to the current market for PCS solutions. PCS technology typically changes and evolves at a significant pace, so the benchmarking information that the benchmarking tool generates can become less significant over time if new data is not entered in it.

### Calculating PCS Fundamental Benchmarking Metrics

The tool will utilize the database to calculate several benchmarking metrics as follows. In some implementations, Tier 2−core system level data can include, for example, * cost per I/O, * material cost per I/O, * hours per I/O, and * services cost per man hour (MH).

### System Calculations

The system can use the data entered into the database to perform a regression analysis to determine the various effects of the Tier 1 and Tier 2 data on the purchase price of the system. This is then used later in the benchmarking activities to derive the agreement analysis and negotiation targets.

### Performing Benchmarking Activities

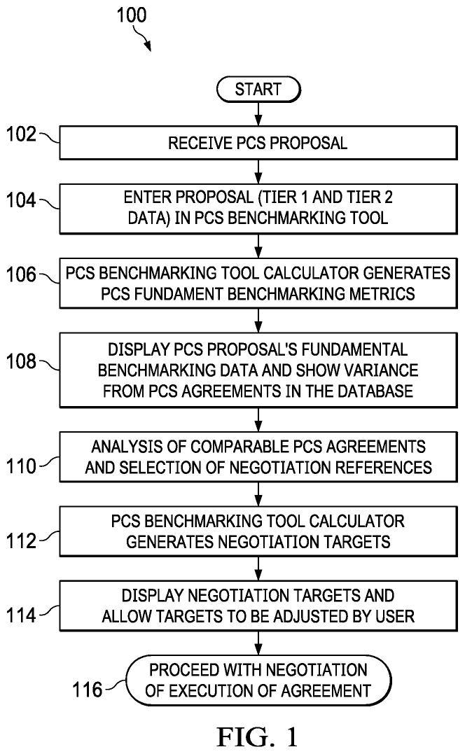

FIG. 1 is a flow diagram showing an example of a workflow 100 for performing benchmark activities, according to some implementations of the present disclosure. A core functionality of the PCS benchmarking tool is to take a current PCS proposal and understand how the proposal compares to previous PCS purchase agreements. From this comparison the evaluator will [symbol] negotiation is required in order to bring the proposal in line with market prices.

At 102, a PCS proposal is received. For example, the proposal can be received by the PCS benchmarking tool from an external source.

Entering Data from PCS Proposal

At 104, Tier 1 and Tier 2 proposal data is entered into the PCS benchmarking tool. For example, to begin the benchmarking process, an evaluator can enter Tier 1 and Tier 2 data (depending on the scope of work defined in the proposal) into the PCS benchmarking tool. Tier 1 proposal level data can include, for example, proposal reference number, proposal date, and project type. Tier 2 core system level data can include, for example, * vendor, * system selection methodology, * value (for example, in USD), * material value (for example, in USD), * services value (for example, in USD), * services hours, and * I/O count.

### Calculating Proposal PCS Fundamental Benchmarking Metrics

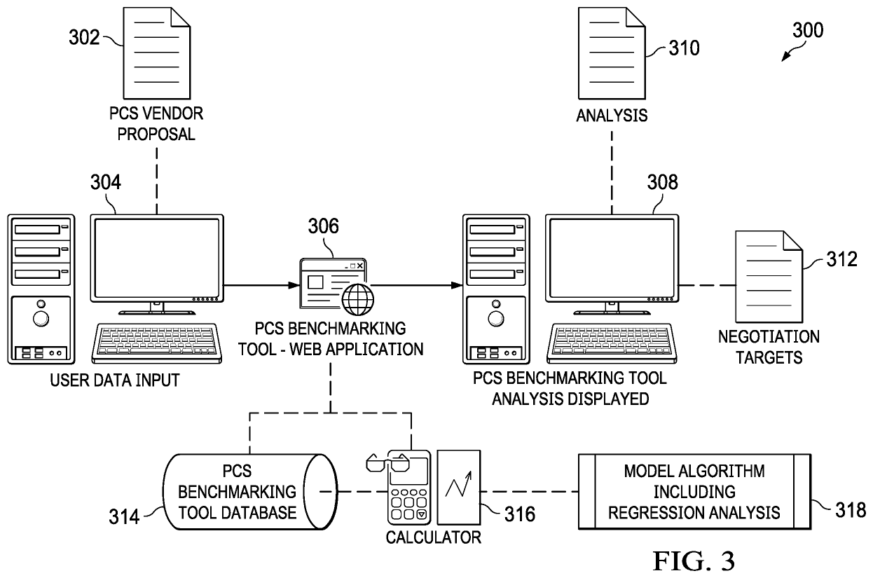

At 106, PCS fundamental benchmarking metrics are calculated. The following calculations can be made by the tool. Tier 2 core system data can include, for example, * cost per I/O, * material cost per I/O, * hours per I/O, and * services cost per MH. At 108, PCS fundamental benchmarking data is displayed (for example, as described with reference to FIG. 3), including showing a variance from past PCS agreements that are stored in the database.

### Benchmarking Activities

A final step is to benchmark the proposal metrics with previous data from signed PCS purchase agreements. The following information, including metrics, can guide the evaluator in their benchmarking activity.

### Understanding the PCS Fundamental Benchmarking Metrics

A cost per I/O value can be used by the evaluator to understand an overall system's relative value based on a number of I/O's the system controls/monitors. This value can considers both material and services, and may be highly variable.

A material cost per I/O value can be used by the evaluator to target the relative value of a material portion of the proposal. The material required to deliver a particular system can typically be highly dependent on the number of I/O's, so this value can be expected to be fairly consistent from one type of project to another. There are several technical aspects in a project's scope that can significantly influence this value, so the evaluator should consider cabinet I/O density and auxiliary material when benchmarking.

The cabinet I/O density can be based on the requirements of the project. In some cases, a vendor may not be able to fully utilize the maximum available space inside a particular cabinet. This can apply not only to the physical space inside the cabinet, but major material components of the system that reside inside the cabinet, such as I/O cards and controllers. The higher the density of the cabinet (for example, number of I/O connections in a particular cabinet), the lower the material cost per I/O.

Auxiliary material corresponds to each system requiring supporting material in order to provide a complete solution for a project. Examples of auxiliary material include workstations, large screen displays, and network devices (for example, switches and servers). The type of auxiliary material required can be highly dependent on the scope of a project, the process the project is controlling, and the facility in which the system will be installed. As the requirements for auxiliary systems increases, the value of the material cost per I/O will also increase.

A man hours per I/O value can be used by the evaluator to target the relative value of the services portion of a proposal. The man hours required to deliver a particular system can be highly dependent on the number of I/O's, so this value can be expected to be fairly consistent from one type of project to another. There are several technical aspects of a project's scope that can effect this value significantly, so the evaluator should consider the variables of process complexity and project environment when benchmarking.

The process complexity can be based on a number of man hours required to deliver a particular system, including a measure of the effort required to complete a number of tasks such as configuration, integration, graphics development, and system testing. The more complex the process or project scope is, the higher the man hours associated with the task, and so the man hours per I/O will also increase.

The project environment can have a significant effect on the number of man hours required to deliver a system. The project environment can be based on project management, an interface with auxiliary systems, project execution strategy, and location(s) of site and project office. As project environmental factors increase, so too will the man hours per I/O associated with the system.

A cost per man hour value can be used by the evaluator to target a relative value of the services portion of a proposal. The value can provide the average cost of all man hours required to deliver the system. Since the activities required to deliver a system are fairly consistent, this value can also be consistent across projects. There are several technical aspects of scope of the project that can effect this value significantly, so the evaluator should consider the variables of resource experience and low-cost engineering centers when benchmarking.

The relative experience of the individuals working to deliver the system may highly effect the cost per man hour. If the project's scope demands highly experienced resources to work on the project, the cost per man hour will increase. If, however, the scope is straightforward, or repetitive in nature (phase-based execution), then lower-skilled or junior resources can be used and will lower the cost per man hour.

Low-cost engineering centers are an emerging trend in the Process Automation Industry (PAS) industry, allowing the use of remote resources from low-cost countries to handle portions of the services required to deliver a system. The use of low-cost engineering centers may be declared or hidden from an end user, but in either case will have the overall effect of lowering the cost per man hour.

### General Benchmarking Considerations

Single source vs. competitive development methodologies can be considered when selecting historical PCS purchase agreements for benchmarking. In this case, the evaluator should understand the development methodology associated with that system. Competitive bidding has a significant downward pressure on the PCS fundamental benchmarking metrics. Although using competitively bid agreements to benchmark single source proposals may provide the evaluator an aspirational target price, it may be extremely hard to achieve in practice.

A PCS purchase agreement scale, used for any material or service purchase, can be the scale of the agreement value will affect PCS fundamental benchmarking metrics. This not only applies to the fixed costs of executing a PCS purchase agreement by the vendor, but also to the relative purchasing power of a vendor who has to purchase their material and services. When selecting a historical agreement with which to benchmark, understanding the overall agreement value to the vendor also factors into the validity of the data on the proposal being evaluated.

### Developing Negotiation Targets

At 110, comparable PCS agreements are analyzed and negotiation references are selected. For example, although benchmarking activities can be performed for multiple purposes, the primary reason is to develop appropriate negotiation targets.

At 112, a PCS benchmarking calculator can generate negotiation targets. For example, using the information from the PCS benchmarking tool can allow the evaluator to developed targets that are based on historical data even when the scope of the agreement is different.

At 114, the negotiation targets can be adjusted by the users, for example, using user interfaces as described with reference to FIG. 3. At 116, the user can proceed with negotiations and execution of the agreement.

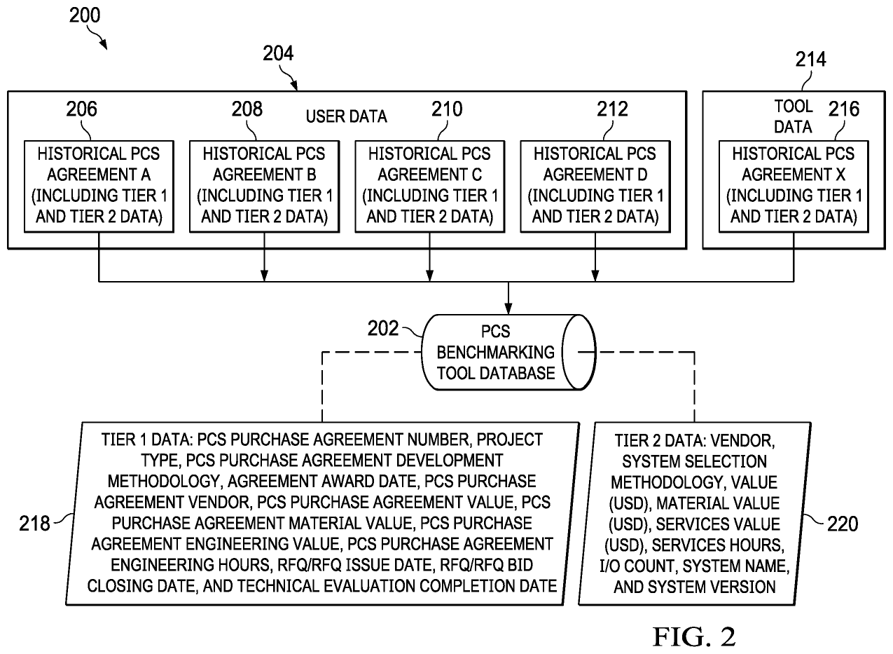

FIG. 2 is a block diagram 200 showing example data inputs to a PCS benchmarking tool database 202, according to some implementations of the present disclosure. User data 204 includes, for example, historical PCS Tier 1 and Tier 2 agreement data 206, 208, 210, and 212 for past agreements A, B, C, and D, respectively. Tool data 214 includes historical PCS Tier 1 and Tier 2 agreement data 216 for agreement X. The database 202 includes Tier 1 data 218 and Tier 2 data 220.

FIG. 3 is a flow diagram showing an example of a workflow 300 for providing user input for benchmark activities and displaying results, according to some implementations of the present disclosure. The workflow 300 includes user interfaces mentioned in the description for FIG. 1, for example.

At 302, a PCS vendor proposal is received. At 304, user data input occurs based on the received PCS vendor proposal, such as using a user interface serving as a front end to the PCS benchmarking tool. At 306, a PCS benchmarking tool web application analyzes the user input data in light of past PCS agreements. At 308, PCS benchmarking tool analysis is displayed, such as to produce analysis reports 310 and negotiation targets 312. The PCS benchmarking tool web application uses the PCS benchmarking tool database 314, a calculator 316, and a model algorithm 318 including regression analysis.

### Determining the Appropriate References

Finding the right agreements or data points to build negotiation targets is a critical step in building a successful negotiation plan. In some implementations, the following information can be considered and evaluated by a proposal evaluator.

A development methodology can be indicative of whether a proposal scope is competitive. This can consider competitive prices that apply to a proposal's scope.

A comparable agreement value can represent a relative agreement value. For example, a vendor cannot offer the same level of discounts on a $1MM agreement as they do on a $50MM agreement.

A year of the agreement value can represent how much time has passed since the reference agreement was signed. Inflation can be a constant pressure on prices, even if technological advances have reduced prices in other areas.

When an average rather than an agreement reference is used, instead of comparing a single value, an average for a given system can be determined from multiple agreements with multiple vendor. This can be used effectively when a vendor consistently charges more than the market does for a given system.

### Determining Upper and Lower Parameters

Once applicable references are determined, the evaluator can calculate upper and lower negotiation parameters using PCS fundamental benchmarking metrics. An upper parameter value can represent the most significant reduction in the proposal price based on reviewed benchmarking data. The evaluator should take care to ensure that this parameter is achievable, as it could undermine the credibility of the negotiation team if the vendor feels that they are being held to unrealistic targets. A lower parameter value can represent the smallest reduction in the proposal price based on the benchmarking data reviewed. This target can also be the “walk-away” price that a negotiation team must receive in order to reach a deal. Any reduction in price that does not meet this target would not be accepted during the negotiation.

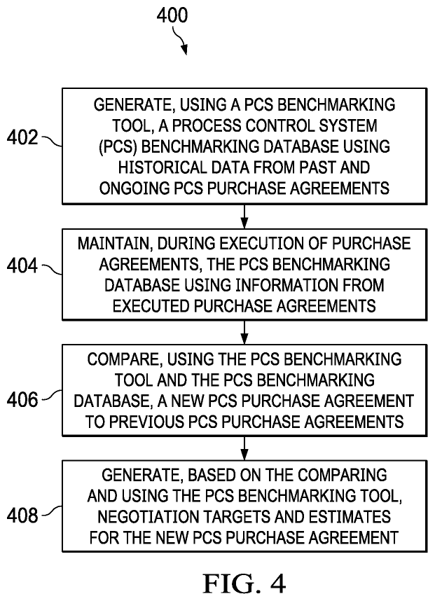

FIG. 4 is a flowchart of an example of a method 400 for generating negotiation targets and estimates using the PCS benchmarking database, according to some implementations of the present disclosure. For clarity of presentation, the description that follows generally describes method 400 in the context of the other figures in this description. However, it will be understood that method 400 can be performed, for example, by any suitable system, environment, software, and hardware, or a combination of systems, environments, software, and hardware, as appropriate. In some implementations, various steps of method 400 can be run in parallel, in combination, in loops, or in any order.

At 402, a process control system (PCS) benchmarking database is generated using historical data from past and ongoing PCS purchase agreements. The database can be the PCS benchmarking tool database 202, for example, generated from the user data 204. Generating the PCS benchmarking database can include annotating each PCS purchase agreement in the PCS benchmarking database as either single source or competitive. The PCS benchmarking database can include information regarding a date range corresponding to the contract period for the PCS purchase agreement. As a result, more recent PCS purchase agreements can be emphasized for analysis with new PCS purchase agreements, and inflation, technology advances, and other time-related factors can be considered. From 402, method 400 proceeds to 404.

At 404, the PCS benchmarking database is maintained during execution of purchase agreements using information from the executed purchase agreements. For example, as additional PCS purchase agreements are bid and accepted, the information from the PCS purchase agreements can be used to update the PCS benchmarking tool database 202. From 404, method 400 proceeds to 406.

In some implementations, method 400 further includes receiving, for example, from a user using a user interface, data associated with a new PCS purchase agreement. For example, the user interface can provide the user with the ability to enter Tier 1 data (including mandatory fields of the new PCS purchase agreement) and Tier 2 data (including optional fields of the new PCS purchase agreement).

At 406, negotiation targets and estimates for a new PCS purchase agreement are generated using the PCS benchmarking database. For example, the steps of the workflow 300 can be used to generate negotiation targets and estimates for us by a user in negotiating a new PCS purchase agreement. After 406, method 400 can stop.

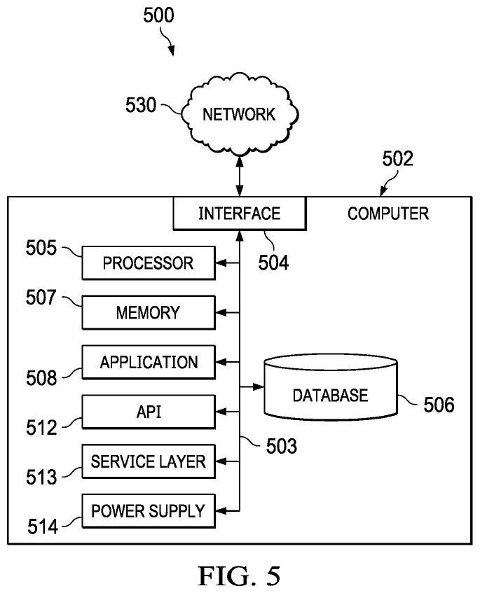

FIG. 5 is a block diagram of an example computer system 500 used to provide computational functionalities associated with described algorithms, methods, functions, processes, flows, and procedures described in the present disclosure, according to some implementations of the present disclosure. The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. Also, the computer 502 can include output devices that can convey information associated with the operation of the computer 502. The information can include digital data, visual data, audio information, or a combination of information. The information can be presented in a graphical user interface (UI) (or GUI).

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a top level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both) over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable. In some implementations, the power supply 514 can include power-conversion and management circuits, including recharging, standby, and power management functionalities. In some implementations, the power-supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

Described implementations of the subject matter can include one or more features, alone or in combination.

For example, in a first implementation, a computer-implemented method includes the following. A process control system (PCS) benchmarking database is generated using a PCS benchmarking tool and historical data from past and ongoing PCS purchase agreements. The PCS benchmarking database is maintained during execution of purchase agreements using information from executed purchase agreements. A new PCS purchase agreement is compared to previous PCS purchase agreements using the PCS benchmarking tool and the PCS benchmarking database. Negotiation targets and estimates for the new PCS purchase agreement are generated using the PCS benchmarking tool based on the comparing.

The foregoing and other described implementations can each, optionally, include one or more of the following features:

A first feature, combinable with any of the following features, where generating the PCS benchmarking database includes annotating the past and ongoing PCS purchase agreements as either single source or competitive.

A second feature, combinable with any of the previous or following features, the method further including: receiving, from a user, Tier 1 data including mandatory fields of the new PCS purchase agreement; and receiving, from the user, Tier 2 data including optional fields of the new PCS purchase agreement.

A third feature, combinable with any of the previous or following features, where the Tier 1 data include PCS purchase agreement number, project type, PCS purchase agreement development methodology, agreement award date, PCS purchase agreement vendor, PCS purchase agreement value, PCS purchase agreement material value, PCS purchase agreement engineering value, and PCS purchase agreement engineering hours.

A fourth feature, combinable with any of the previous or following features, where the Tier 2 data includes additional project references, request for quote (RFQ)/RFQ issue date, RFQ/RFQ bid closing date, technical evaluation completion date, commercial evaluation completion date, and cost savings.

A fifth feature, combinable with any of the previous or following features, where generating the negotiation targets and the estimates for the new PCS purchase agreement includes using PCS fundamental benchmarking metrics.

A sixth feature, combinable with any of the previous or following features, where the PCS fundamental benchmarking metrics include a cost per input/output (I/O) value, a material cost per I/O value, a cabinet I/O density, and a man hours per I/O value.

In a second implementation, a non-transitory, computer-readable medium stores one or more instructions executable by a computer system to perform operations including the following. A process control system (PCS) benchmarking database is generated using a PCS benchmarking tool and historical data from past and ongoing PCS purchase agreements. The PCS benchmarking database is maintained during execution of purchase agreements using information from executed purchase agreements. A new PCS purchase agreement is compared to previous PCS purchase agreements using the PCS benchmarking tool and the PCS benchmarking database. Negotiation targets and estimates for the new PCS purchase agreement are generated using the PCS benchmarking tool based on the comparing.

The foregoing and other described implementations can each, optionally, include one or more of the following features:

A first feature, combinable with any of the following features, where generating the PCS benchmarking database includes annotating the past and ongoing PCS purchase agreements as either single source or competitive.

A second feature, combinable with any of the previous or following features, the operations further including: receiving, from a user, Tier 1 data including mandatory fields of the new PCS purchase agreement; and receiving, from the user, Tier 2 data including optional fields of the new PCS purchase agreement.

A third feature, combinable with any of the previous or following features, where the Tier 1 data include PCS purchase agreement number, project type, PCS purchase agreement development methodology, agreement award date, PCS purchase agreement vendor, PCS purchase agreement value, PCS purchase agreement material value, PCS purchase agreement engineering value, and PCS purchase agreement engineering hours.

A fourth feature, combinable with any of the previous or following features, where the Tier 2 data includes additional project references, request for quote (RFQ)/RFQ issue date, RFQ/RFQ bid closing date, technical evaluation completion date, commercial evaluation completion date, and cost savings.

A fifth feature, combinable with any of the previous or following features, where generating the negotiation targets and the estimates for the new PCS purchase agreement includes using PCS fundamental benchmarking metrics.

A sixth feature, combinable with any of the previous or following features, where the PCS fundamental benchmarking metrics include a cost per input/output (I/O) value, a material cost per I/O value, a cabinet I/O density, and a man hours per I/O value.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following. A process control system (PCS) benchmarking database is generated using a PCS benchmarking tool and historical data from past and ongoing PCS purchase agreements. The PCS benchmarking database is maintained during execution of purchase agreements using information from executed purchase agreements. A new PCS purchase agreement is compared to previous PCS purchase agreements using the PCS benchmarking tool and the PCS benchmarking database. Negotiation targets and estimates for the new PCS purchase agreement are generated using the PCS benchmarking tool based on the comparing.

The foregoing and other described implementations can each, optionally, include one or more of the following features:

A first feature, combinable with any of the following features, where generating the PCS benchmarking database includes annotating the past and ongoing PCS purchase agreements as either single source or competitive.

A second feature, combinable with any of the previous or following features, the operations further including: receiving, from a user, Tier 1 data including mandatory fields of the new PCS purchase agreement; and receiving, from the user, Tier 2 data including optional fields of the new PCS purchase agreement.

A third feature, combinable with any of the previous or following features, where the Tier 1 data include PCS purchase agreement number, project type, PCS purchase agreement development methodology, agreement award date, PCS purchase agreement vendor, PCS purchase agreement value, PCS purchase agreement material value, PCS purchase agreement engineering value, and PCS purchase agreement engineering hours.

A fourth feature, combinable with any of the previous or following features, where the Tier 2 data includes additional project references, request for quote (RFQ)/RFQ issue date, RFQ/RFQ bid closing date, technical evaluation completion date, commercial evaluation completion date, and cost savings.

A fifth feature, combinable with any of the previous or following features, where generating the negotiation targets and the estimates for the new PCS purchase agreement includes using PCS fundamental benchmarking metrics.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY.

The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
generating, using a PCS benchmarking tool, a process control system (PCS) benchmarking database using historical data from past and ongoing PCS purchase agreements;
maintaining, during execution of purchase agreements, the PCS benchmarking database using information from executed purchase agreements;
comparing, using the PCS benchmarking tool and the PCS benchmarking database, a new PCS purchase agreement to previous PCS purchase agreements; and
generating, based on the comparing and using the PCS benchmarking tool, negotiation targets and estimates for the new PCS purchase agreement.

2. The computer-implemented method of claim 1, wherein generating the PCS benchmarking database includes annotating the past and ongoing PCS purchase agreements as either single source or competitive.

3. The computer-implemented method of claim 1, further comprising:
receiving, from a user, Tier 1 data including mandatory fields of the new PCS purchase agreement; and
receiving, from the user, Tier 2 data including optional fields of the new PCS purchase agreement.

4. The computer-implemented method of claim 3, wherein the Tier 1 data include PCS purchase agreement number, project type, PCS purchase agreement development methodology, agreement award date, PCS purchase agreement vendor, PCS purchase agreement value, PCS purchase agreement material value, PCS purchase agreement engineering value, and PCS purchase agreement engineering hours.

5. The computer-implemented method of claim 3, wherein the Tier 2 data includes additional project references, request for quote (RFQ)/RFQ issue date, RFQ/RFQ bid closing date, technical evaluation completion date, commercial evaluation completion date, and cost savings.

6. The computer-implemented method of claim 1, wherein generating the negotiation targets and the estimates for the new PCS purchase agreement includes using PCS fundamental benchmarking metrics.

7. The computer-implemented method of claim 1, wherein the PCS fundamental benchmarking metrics include a cost per input/output (I/O) value, a material cost per I/O value, a cabinet I/O density, and a man hours per I/O value.

8. A non-transitory, computer-readable medium storing one or more instructions executable by a computer system to perform operations comprising:
generating, using a PCS benchmarking tool, a process control system (PCS) benchmarking database using historical data from past and ongoing PCS purchase agreements;
maintaining, during execution of purchase agreements, the PCS benchmarking database using information from executed purchase agreements;
comparing, using the PCS benchmarking tool and the PCS benchmarking database, a new PCS purchase agreement to previous PCS purchase agreements; and
generating, based on the comparing and using the PCS benchmarking tool, negotiation targets and estimates for the new PCS purchase agreement.

9. The non-transitory, computer-readable medium of claim 8, wherein generating the PCS benchmarking database includes annotating the past and ongoing PCS purchase agreements as either single source or competitive.

10. The non-transitory, computer-readable medium of claim 8, the operations further comprising:
receiving, from a user, Tier 1 data including mandatory fields of the new PCS purchase agreement; and
receiving, from the user, Tier 2 data including optional fields of the new PCS purchase agreement.

11. The non-transitory, computer-readable medium of claim 10, wherein the Tier 1 data include PCS purchase agreement number, project type, PCS purchase agreement development methodology, agreement award date, PCS purchase agreement vendor, PCS purchase agreement value, PCS purchase agreement material value, PCS purchase agreement engineering value, and PCS purchase agreement engineering hours.

12. The non-transitory, computer-readable medium of claim 10, wherein the Tier 2 data includes additional project references, request for quote (RFQ)/RFQ issue date, RFQ/RFQ bid closing date, technical evaluation completion date, commercial evaluation completion date, and cost savings.

13. The non-transitory, computer-readable medium of claim 8, wherein generating the negotiation targets and the estimates for the new PCS purchase agreement includes using PCS fundamental benchmarking metrics.

14. The non-transitory, computer-readable medium of claim 8, wherein the PCS fundamental benchmarking metrics include a cost per input/output (I/O) value, a material cost per I/O value, a cabinet I/O density, and a man hours per I/O value.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
generating, using a PCS benchmarking tool, a process control system (PCS) benchmarking database using historical data from past and ongoing PCS purchase agreements;
maintaining, during execution of purchase agreements, the PCS benchmarking database using information from executed purchase agreements;
comparing, using the PCS benchmarking tool and the PCS benchmarking database, a new PCS purchase agreement to previous PCS purchase agreements; and
generating, based on the comparing and using the PCS benchmarking tool, negotiation targets and estimates for the new PCS purchase agreement.

16. The computer-implemented system of claim 15, wherein generating the PCS benchmarking database includes annotating the past and ongoing PCS purchase agreements as either single source or competitive.

17. The computer-implemented system of claim 15, the operations further comprising:
receiving, from a user, Tier 1 data including mandatory fields of the new PCS purchase agreement; and
receiving, from the user, Tier 2 data including optional fields of the new PCS purchase agreement.

18. The computer-implemented system of claim 17, wherein the Tier 1 data include PCS purchase agreement number, project type, PCS purchase agreement development methodology, agreement award date, PCS purchase agreement vendor, PCS purchase agreement value, PCS purchase agreement material value, PCS purchase agreement engineering value, and PCS purchase agreement engineering hours.

19. The computer-implemented system of claim 17, wherein the Tier 2 data includes additional project references, request for quote (RFQ)/RFQ issue date, RFQ/RFQ bid closing date, technical evaluation completion date, commercial evaluation completion date, and cost savings.

20. The computer-implemented system of claim 15, wherein generating the negotiation targets and the estimates for the new PCS purchase agreement includes using PCS fundamental benchmarking metrics.
